(19) United States
(12) Patent Application Publication
(10) Pub. No.: US 2019/0065946 A1
(43) Pub. Date: Feb. 28, 2019

(54) MACHINE LEARNING DEVICE AND MACHINE LEARNING METHOD

(71) Applicant: Hitachi, Ltd., Tokyo (JP)

(72) Inventors: Katsuto SATO, Tokyo (JP); Yuki KONDOH, Tokyo (JP); Hiroaki AKUTSU, Tokyo (JP)

(21) Appl. No.: 15/979,711

(22) Filed: May 15, 2018

(30) Foreign Application Priority Data
Aug. 30, 2017 (JP) 2017-165327

(51) Int. Cl. G06N 3/08; G06F 7/58

(52) U.S. Cl. CPC G06N 3/08; G06F 7/58

(57) ABSTRACT

An activation state decision unit includes a plurality of parameter units made to process data on the basis of parameters respectively managed thereby. Each of the parameter units includes a number generator that generates a numerical number a sign of which varies, a number processor (such as an adder) that creates a parameter to process the data on the basis of the parameter and the numerical number generated by the number generator, and a parameter updating unit that updates the parameter on the basis of a cost value, which is acquired by evaluation of the processed data by an evaluation system, and the numerical number generated by the number generator. The number generator changes the generated numerical number in each data processing, and generates the numerical number in such a manner that order of a sign variation of the numerical number varies between the parameter units.

### BACKGROUND OF THE INVENTION

### 1. Field of the Invention

An embodiment of the present invention relates to a machine learning device and a machine learning method, and specifically relates to learning of a parameter in machine learning.

### 2. Description of the Related Art

By development of machine learning, a technology of acquiring useful knowledge with a few man-hours on the basis of a large amount of data is in practical use. In machine learning, an inference system using a neural network is reaching practicable accuracy in a specific field such as image recognition or language translation and further development is expected.

In neural network-based machine learning, back propagation is widely used as a method of learning (adjusting) a parameter of a network. By the back propagation, a gradient with respect to a cost function for determination of a direction in which a parameter is to be adjusted can be calculated with a less computational load than numerical differentiation. Recently, deep learning in which the number of stages of a network is increased is widely tried to accurately infer an approximate solution of a complicated problem. The back propagation is an essential technology to control a computational load increased along with an increase in the number of stages of a network in deep learning.

On the other hand, learning cannot be performed in the back propagation unless a cost function is defined by a differentiable and programmable mathematical formula. Since a problem of classifying digitalized data on the basis of a probabilistic logic or a statistical theory is major in a current application example, a cost function formula is logically calculated. However, in a case where an approximate solution is calculated with a neural network being widely used with respect to an actual problem, there is a case where definition of a mathematical formula of a cost function is difficult although evaluation of an output can be performed. For example, in a case where physical action is applied to a real world on the basis of an output of a neural network and a result thereof is observed, a mathematical formula cannot be defined unless a model about the physical action and the result is defined.

With the numerical differentiation, learning is possible as long as an evaluation result is acquired even when a mathematical formula of a cost function is not defined. However, since the number of parameters to be adjusted becomes large in a case where deep learning is performed, a calculation amount becomes enormous and it becomes almost impossible to acquire an approximate solution in a realistic period in the numerical differentiation.

To apply deep learning to a wider field (such as case where cost function is non-differentiable or field in which definition of mathematical formula is difficult), a method of estimating a gradient for parameter adjustment other than numerical differentiation or back propagation in a related art is desired.

For example, a method of making a machine learning system perform learning in a case where a cost function is discontinuous and non-differentiable is disclosed in JP 2009-515231 W (WO2007/011529). Since an evaluation algorithm of a web page has a discontinuous and non-differentiable property, this learning method is a method of calculating an estimation value of a gradient by performing transformation, in a certain rule, of a value output from the non-differentiable algorithm and of performing learning on the basis of the gradient.

### SUMMARY OF THE INVENTION

In a case where definition of a mathematical formula of a cost function is difficult or is non-differentiable even when definition can be made, back propagation cannot be used when machine learning is performed by utilization of the cost function. Thus, it is necessary to use numerical differentiation in a case where learning is performed under such a condition. However, it is difficult to complete calculation in a realistic period since a calculation amount is large in the numerical differentiation. In the numerical differentiation, a parameter is changed one by one and a gradient of the parameter is estimated from a variation in a cost value with respect to the change thereof. Thus, in a case where the number of parameters is N, a calculation amount, which is necessary for gradient estimation performed once, such as the number of product-sum operations becomes O(N²) and a calculation amount necessary until learning is completed becomes enormous in a complicated network. Thus, it is difficult to acquire a model in a practical scale by machine learning with the numerical differentiation.

An object of an embodiment of the present invention is to reduce a calculation amount necessary for learning in machine learning.

Unlike numerical differentiation of changing a parameter one by one, a plurality of parameters is changed simultaneously and a calculation amount necessary until learning is completed is reduced in machine learning according to an embodiment of the present invention. When a plurality of parameters is simultaneously changed, a direction of changing the parameters is decided by utilization of numerical sequences with small correlation, and the acquired cost value variation sequence is integrated by being multiplied by a positive or negative sign according to the direction in which the parameters are changed, whereby influence quantities of the simultaneously-changed parameters on a cost value are separated, a gradient is estimated, and adjustment of the parameters is executed.

A preferred example of the present invention is a machine learning system including: an activation state decision unit that changes data on the basis of a parameter and that processes and outputs the data, wherein the activation state decision unit includes a plurality of parameter units that is made to process the data on the basis of parameters respectively managed thereby, each of the plurality of parameter units includes a number generator that generates a numerical number a sign of which varies, a number processor that creates a parameter to process the data on the basis of the parameter and the numerical number generated by the number generator, and a parameter updating unit that updates the parameter on the basis of a cost value, which is acquired by evaluation of the processed data by an evaluation system, and the numerical number generated by the number generator, and the number generator changes the generated numerical number in each data processing, and generates the numerical number in such a manner that order of a sign variation of the numerical number varies between the parameter units.

According to an embodiment of the present invention, a calculation amount necessary for learning in machine learning can be decreased.

### BRIEF DESCRIPTION OF THE DRAWINGS

FIG. 1 is a view illustrating a whole configuration of a machine learning system;

FIG. 2 is a view illustrating a configuration of a data processing system;

FIG. 3 is a view illustrating a hardware configuration of the data processing system;

FIG. 4 is a view illustrating a configuration of a control unit;

FIG. 5 is an operation flowchart of the control unit;

FIG. 6 is a view illustrating a configuration of a learning completion determination unit;

FIG. 7 is an operation flowchart of the learning completion determination unit;

FIG. 8 is a view illustrating a configuration of an activation state decision unit;

FIG. 9 is a view illustrating a configuration of a parameter unit;

FIG. 10 is an operation flowchart of the parameter unit;

FIG. 11 is a view illustrating a configuration of a parameter updating unit;

FIG. 12 is an operation flowchart of the parameter updating unit;

FIG. 13 is a view illustrating a configuration of a number generator;

FIG. 14 is a view illustrating a configuration of a pseudo random number generator;

FIG. 15 is a view illustrating an example of a setting screen of a learning condition;

FIG. 16 is a view illustrating a configuration of a number generator in a second embodiment;

FIG. 17 is a view illustrating a configuration of a parameter updating unit in a third embodiment;

FIG. 18 is an operation flowchart of the parameter updating unit in the third embodiment;

FIG. 19 is a view illustrating a configuration of a filter circuit in the third embodiment;

FIG. 20 is a view illustrating a configuration of a control unit in a fourth embodiment;

FIG. 21 is an operation flowchart of the control unit in the fourth embodiment;

FIG. 22 is a view illustrating a configuration of a learning completion determination unit in the fourth embodiment; and

FIG. 23 is an operation flowchart of the learning completion determination unit in the fourth embodiment.

### DESCRIPTION OF THE PREFERRED EMBODIMENTS

In the following, preferred embodiments of the present invention will be described with reference to the drawings.

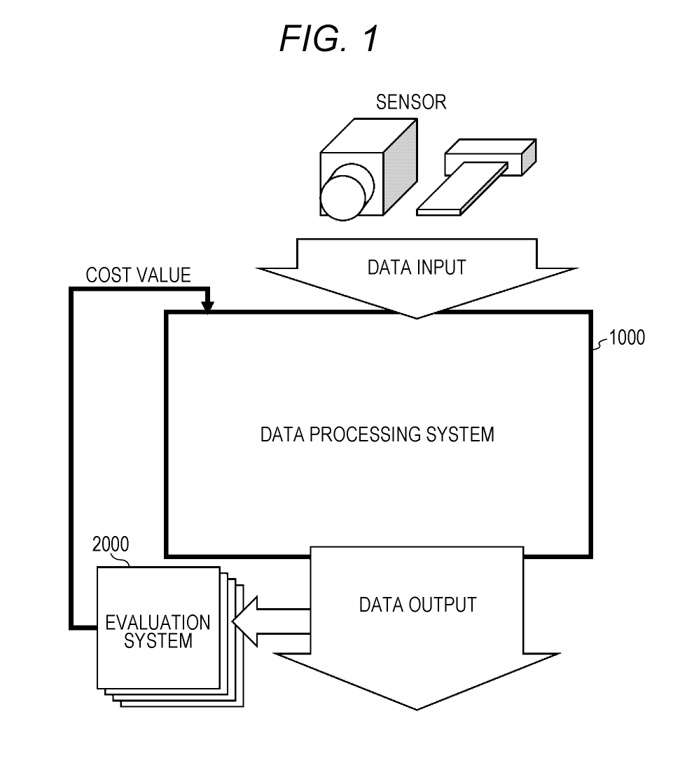

FIG. 1 is a view illustrating a whole configuration of a machine learning system. The machine learning system includes a data processing system 1000 and an evaluation system 2000 that evaluates a learning result. The data processing system 1000 mainly performs machine learning, receives information necessary for learning (such as plurality of piece of sensor information) as a data input, performs learning processing, and outputs data. The evaluation system 2000 performs evaluation of a learning result that is output information from the data processing system 1000. The data processing system 1000 is, for example, a server. The evaluation system 2000 is a system that operates independently of the data processing system 1000.

The data processing system 1000 receives one or more inputs, and one or more cost values from the evaluation system 2000, and generates one or more outputs. The data processing system 1000 has two operation modes that are an inference mode and a learning mode. In the inference mode, processing based on a value of a parameter is performed and an output is generated. In the learning mode, processing is performed in a state in which a value of a parameter is slightly changed, and an output is generated. In the learning mode, a plurality of outputs, in which a change pattern of a parameter is changed, can be generated with respect to one input.

The evaluation system 2000 evaluates a degree of correspondence between an output of the data processing system 1000 and a processing object, and outputs a quantitative cost value. The evaluation is constantly performed regardless of an operation mode of the data processing system 1000 in a learning period. The evaluation system 2000 not only evaluates an output of a data processing system directly but may also perform physical action by using an output of a data processing system and monitor and evaluate a result thereof. For example, a machine may be operated on the basis of an output result of the data processing system 1000, a result of the operation may be subjectively evaluated by a human, and the graded result may be used as a cost value. In a case of such a configuration, in terms of a machine learning system, the evaluation system 2000 is not limited to a computer such as a server, and includes an information processing device such as a machine that performs physical action, a monitoring device such as a monitoring camera, or a terminal into which a cost value is input in a case where a human performs evaluation.

First, a principle used to simultaneously change a plurality of parameters and perform learning is described.

In a preferred example of the present invention, a characteristic in which correlation between a pair of numerical sequences generated by a pair of number generators 300a and 300b with an equal phase is high and correlation between a pair of numerical sequences generated by a pair of number generators 300a and 300c with different phases is low is used as a property of a number generator 300 having a numerical number generation phase. The number generator 300 generates a positive (+1) or negative (−1) numerical sequence. In a case where a generation cycle is T, numerical sequences Cn and Cm generated from different phase settings satisfy the following Formula 1.

$$[ Mathematical Formula 1 ]$$

$$\vec{{C}_{n}} \cdot \vec{{C}_{n}} = {\sum }_{t = 0}^{T} \vec{{C}_{n}} ( i ) \cdot \vec{{C}_{n}} ( i ) = T , \vec{{C}_{n}} \cdot \vec{{C}_{m}} = {\sum }_{t = 0}^{T} \vec{{C}_{n}} ( i ) \cdot \vec{{C}_{m}} ( i ) ≅ 0. \qquad Formula 1$$

Note that numerical sequences \vec{Cn} and \vec{Cm} are expressed as Cn and Cm in a body text of the specification as a matter of convenience. The same shall be applied to expression of a different numerical sequence.

That is, a value in which a product of a pair of numerical sequences acquired from number generators of the same phase is accumulated for the cycle T of the number generators becomes the cycle T, and a value in which a product of a pair of numerical sequences acquired from number generators of different phases is accumulated for the cycle T of the number generators becomes asymptotic to 0. This property is a basic principle used in code division multiplexing.

An influence of a parameter on a cost value is estimated by utilization of this property. In numerical differentiation, a parameter is changed one by one and an influence quantity of the parameter on a cost value is estimated. On the other hand, in an embodiment of the present invention, a parameter is changed in a pattern corresponding to a numerical sequence acquired from a number generator, processing is executed after a plurality of parameters is changed simultaneously, and a cost value sequence is acquired. Each element included in this cost value sequence is in a state in which influence quantities of parameters are mixed. However, since the parameters are changed in different patterns, only an influence quantity of a q-th parameter can be extracted by multiplication and integration of a numerical sequence, which defines a change pattern of the q-th parameter, and a cost value sequence.

A mathematical assumption and a procedure of gradient estimation are described in the following. A numerical sequence (Formula 2) in which a value pₖ of a k-th parameter in a data processing system is changed slightly in positive and negative directions according to a numerical sequence Ck of a length T is created.

[Mathematical Formula 2]

\vec{Pₖ}=pₖ+ϵ\vec{Cₖ}={pₖ+ϵ\vec{Cₖ}(0),pₖ+ϵ\vec{Cₖ}(1), . . . pₖ+ϵ\vec{Cₖ}(T−1)} Formula 2

The same input data is put through the data processing system and processing is performed by utilization of an m-th element of each of pk created for the number of parameters, and a numerical sequence including an output result thereof which result is evaluated for T times by an evaluation system is a cost value sequence E. Note that in a case where there is a plurality of evaluation systems, a numerical sequence includes a cost value weighted according to a parameter register 1500 that sets a degree of importance of each evaluation system. It is assumed that an m-th configuration element of this cost value sequence E can be approximated in a manner of an Formula 3 when a cost value with respect to a processing result of when a parameter is not changed is E₀. Note that a gradient value gₖ of a k-th parameter is a variation amount of a cost value of when the parameter is changed for a small value ε by numerical differentiation with a parameter other than the k-th parameter as a fixed value.

$$[ Mathematical Formula 3 ]$$

$$\vec{E} ( t ) = {E}_{O} + ϵ \cdot {\sum }_{k = 0}^{K} {ℊ}_{k} \cdot \vec{{C}_{k}} ( t ) = {E}_{O} + ϵ \{ {ℊ}_{0} \cdot \vec{{C}_{0}} ( t ) + {ℊ}_{1} \cdot \vec{{C}_{1}} ( t ) + ⋯ + {ℊ}_{K} \cdot \vec{{C}_{K}} ( t ) \} \qquad Formula 3$$

This assumption indicates that a variation amount of a cost value of when a plurality of parameters is changed simultaneously can be expressed by linear combination of when a parameter is changed individually. Actually, an activation state decision unit or an evaluation system inside the data processing system has non-linearity. However, in an embodiment of the present invention, it is possible to assume that linear approximation is performed with respect to a true gradient value.

In an embodiment of the present invention, a gradient value g of a parameter is to be calculated. In a case where a gradient g_{q} of a q-th parameter is calculated from the above-described Formula 3, transformation into an Formula 4 is performed.

$$[ Mathematical Formula 4 ]$$

$$\frac{\vec{E} ( t ) - {E}_{O}}{ϵ} = {\sum }_{k = 0}^{K} {ℊ}_{k} \cdot \vec{{C}_{k}} ( t ) \qquad Formula 4$$

Here, by utilization of a numerical sequence Cq used when the q-th parameter is changed, calculation of an Formula 5 in the below in which each of trials for T times is multiplied by the numerical sequence Cq is performed.

$$[ Mathematical Formula 5 ]$$

$${\sum }_{t = 0}^{T - 1} \vec{{C}_{q}} ( t ) \cdot \frac{\vec{E} ( t ) - {E}_{O}}{ϵ} = {\sum }_{t = 0}^{T - 1} \vec{{C}_{q}} ( t ) {\sum }_{k = 0}^{K} {ℊ}_{k} \cdot \vec{{C}_{k}} ( t ) \qquad Formula 5$$

Here, in a case where the numerical sequences Ck and Cq are multiplied for a period of the cycle T and accumulation calculation thereof is performed, a result thereof converges into T in a case where q=k and converges into 0 in a case where q≠k according to the above definition. Thus, g_{q} can be calculated from an Formula 6 and an Formula 7 in the below.

$$[ Mathematical Formula 6 ]$$

$$\begin{matrix}{\sum }_{t = 0}^{T - 1} \vec{{C}_{q}} ( t ) \cdot \frac{\vec{E} ( t ) \cdot {E}_{O}}{ϵ} = {ℊ}_{q} \cdot T \\ [ Mathematical Formula 7 ] & Formula 6 \\ {ℊ}_{q} = \frac{1}{T} {\sum }_{t = 0}^{T - 1} \vec{{C}_{q}} ( t ) \cdot \frac{\vec{E} ( t ) - {E}_{O}}{ϵ} & Formula 7\end{matrix}$$

Trials for T times are necessary to calculate an approximate solution by application of this mathematical rule. A value of T is a cycle of a number generator at maximum. A smaller value can be used by allowance of an error in gradient estimation. As T becomes smaller in the above-described calculation process, an accumulated multiplication value of the numerical sequences Ck and Cq becomes less likely to converge into 0 in a case where q≠k. Thus, an error component is generated. However, since a ratio of the error component and a gradient component becomes 1:T, it can be expected that the error component becomes small in inverse proportion to T. Thus, in practice, it is possible to make a value of T smaller than a cycle of a number generator and to adjust a parameter.

In a case where an error is allowed, the theoretically necessary minimum number of times of processing becomes log₂K in a case where the number of parameters is K. This is because a length of a numerical sequence needs to be log₂K or longer in such a manner that a numerical sequence Cₖ in which all parameters are in different patterns is included. However, there is a phase state in which numerical sequences in different patterns cannot be respectively assigned to all parameters by processing for log₂K times due to a property of the number generator 300. Also, it is necessary to make an influence of different parameters adequately asymptotic to 0. Thus, the number of times of processing needs to be larger than this value in practice.

### First Embodiment

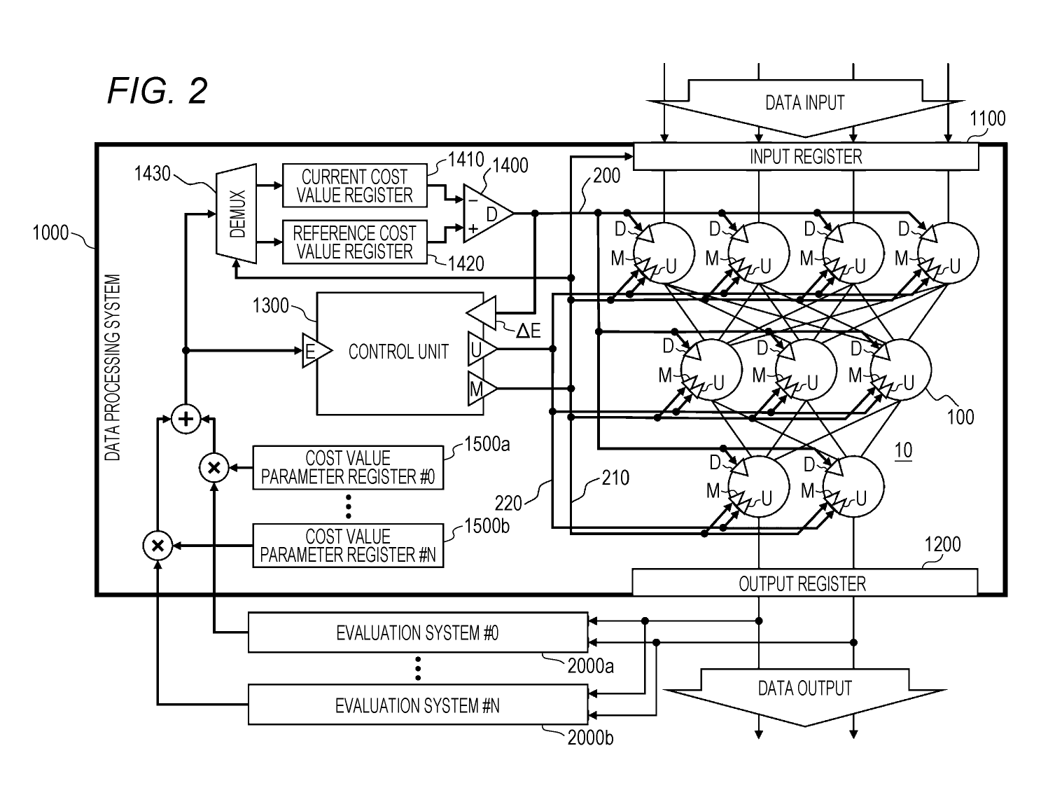

FIG. 2 is a view illustrating a detailed configuration of the data processing system 1000.

The data processing system 1000 includes a plurality of activation state decision units 100, a cost difference broadcast path 200, an operation mode broadcast path 210, a parameter update signal broadcast path 220, an input register 1100, an output register 1200, a control unit 1300, a cost difference calculator 1400, a current cost value register 1410, a reference cost value register 1420, a cost value register selector 1430, an evaluation value parameter register 1500, and a peripheral circuit. The activation state decision unit 100 is included in an artificial neuron. Here, an aggregation of the plurality of activation state decision units 100 is referred to as an activation state decision unit group 10. Data input into the data processing system 1000 is held in the input register 1100, processing is performed while the input data passes through the activation state decision unit group 10, and a result of the processing is stored into the output register 1200.

The input register 1100 receives an operation mode signal from the control unit 1300. In a case where it is detected that an operation mode is a learning mode, even when an input signal from the outside varies, a value thereof is not imported and a current value is held. On the other hand, in a case where it is detected that an operation mode is an inference mode, an input signal from the outside is imported and a state of the input register 1100 is updated.

The cost value register selector 1430 receives an operation mode signal from the control unit 1300. In a case where it is detected that an operation mode is a learning mode, the current cost value register 1410 is rewritten with a cost value input into the selector 1430. In a case where an inference mode is detected, the reference cost value register 1420 is rewritten.

A plurality of cost value parameter registers 1500 register parameter values that vary depending on a plurality of evaluation systems 2000. A parameter value is decided in designing of a machine learning system and is set in each cost value parameter register 1500 at a stage of initialization before leaning of this system is started. Note that in a case where there is only one evaluation system 2000, a cost value parameter register 1500 may be omitted.

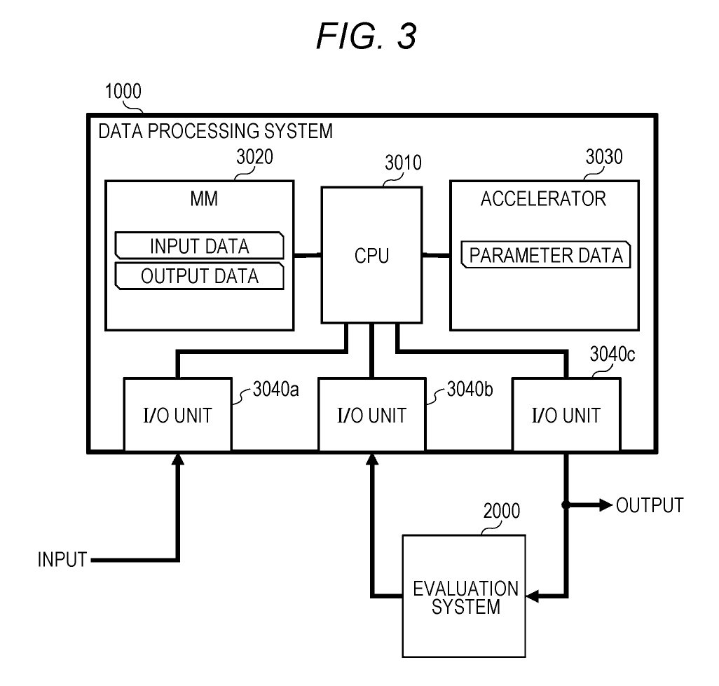

FIG. 3 is a view illustrating a hardware configuration of the data processing system 1000.

The data processing system includes an input/output device 3040a that receives input data from the outside, an input/output device 3040b that receives evaluation from an evaluation system, an input/output device 3040c that outputs a result of calculation by the data processing system, a CPU 3010, a main memory 3020, and an accelerator 3030 in which the activation state decision unit group 10 is mounted. An input/output device 3040 is, for example, a network interface card (NIC), a host bus adapter (HBA), or a host channel adapter (HCA). Note that the input/output device 3040 includes an input unit such as a keyboard or a mouse with which data input is performed, and a display unit that displays data.

The accelerator 3030 includes a field-programmable gate array (FPGA), an application specific integrated circuit (ASIC), a coprocessor group that can execute a miniprogram, or the like. The main memory 3020 holds input data, output data, a current cost value, a reference cost value, and the like. The CPU 3010 executes a program related to an operation of the control unit 1300 or the cost difference calculator 1400. Note that a function corresponding to an operation of a control unit or a cost differential device may be formed as hardware in the accelerator 3030. In that case, the CPU 3010 performs input/output processing.

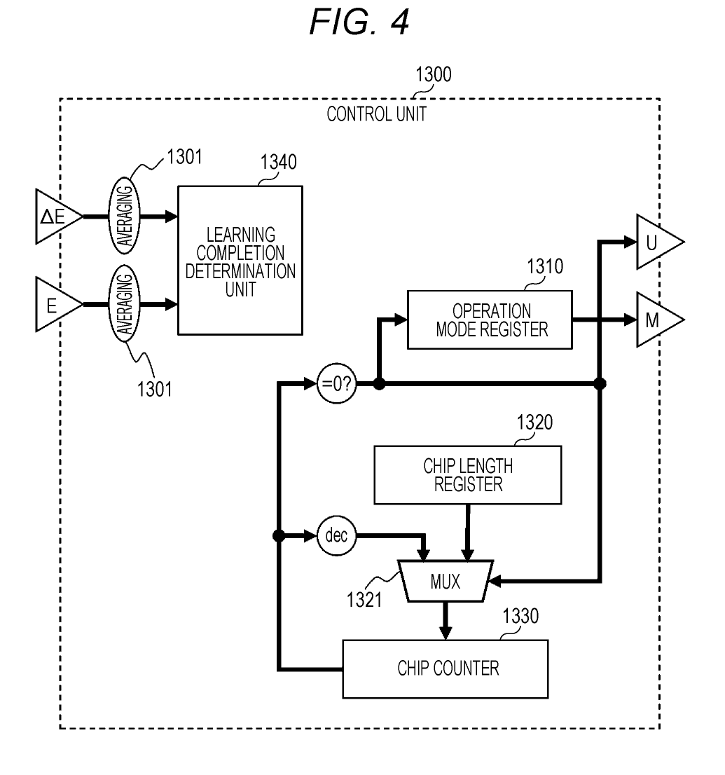

FIG. 4 is a view illustrating a configuration of the control unit 1300.

The control unit 1300 decides an operation mode of the data processing system 1000 and controls an operation of the other configuration elements. The control unit 1300 includes an operation mode register 1310 that holds an operation mode, a chip length register 1320 that holds the number of cycles of performing learning, a chip counter 1330 that holds the current number of cycles, and a learning completion determination unit 1340 that monitors a cost value and detects completion of learning. The control unit 1300 also includes a port E that receives a value of a current cost value from the outside, a port ΔE that receives a cost value difference, a port M that outputs a current operation mode, and a port U that outputs parameter update timing.

There are two operation modes that are an inference mode and a learning mode. In the inference mode, only processing of generating output data from input data is executed and a parameter is not updated. In the learning mode, one or more outputs are generated from one piece of input data, a gradient necessary for updating a parameter is calculated by utilization of a cost value from the evaluation system 2000, and the parameter is updated. As one step progresses, a value of the chip counter 1330 is subtracted via a selector 1321. When the value of the chip counter 1330 becomes 0, a value of the chip length register 1320 is input into the chip counter and a next learning cycle is started.

The operation mode register 1310 stores a value indicating the learning mode in a case where a value of the chip counter is other than 0, and stores a value indicating the inference mode in a case where the value is 0. Also, timing at which a value of the chip counter 1330 varies from 1 to 0 is detected and a parameter update signal is transmitted. The learning completion determination unit 1340 receives a current cost value and a variation amount of the cost value from the port E and the port ΔE through an averaging arithmetic unit 1301 and determines whether learning is completed. The averaging arithmetic unit accumulates a value from the outside while the operation mode is the learning mode, and calculates an average value and supplies this to the learning completion determination unit 1340 at switching to the inference mode. By receiving an average value, the learning completion determination unit 1340 prevents erroneous determination of learning completion due to a variation of a cost value at each time of processing in a period of the learning mode.

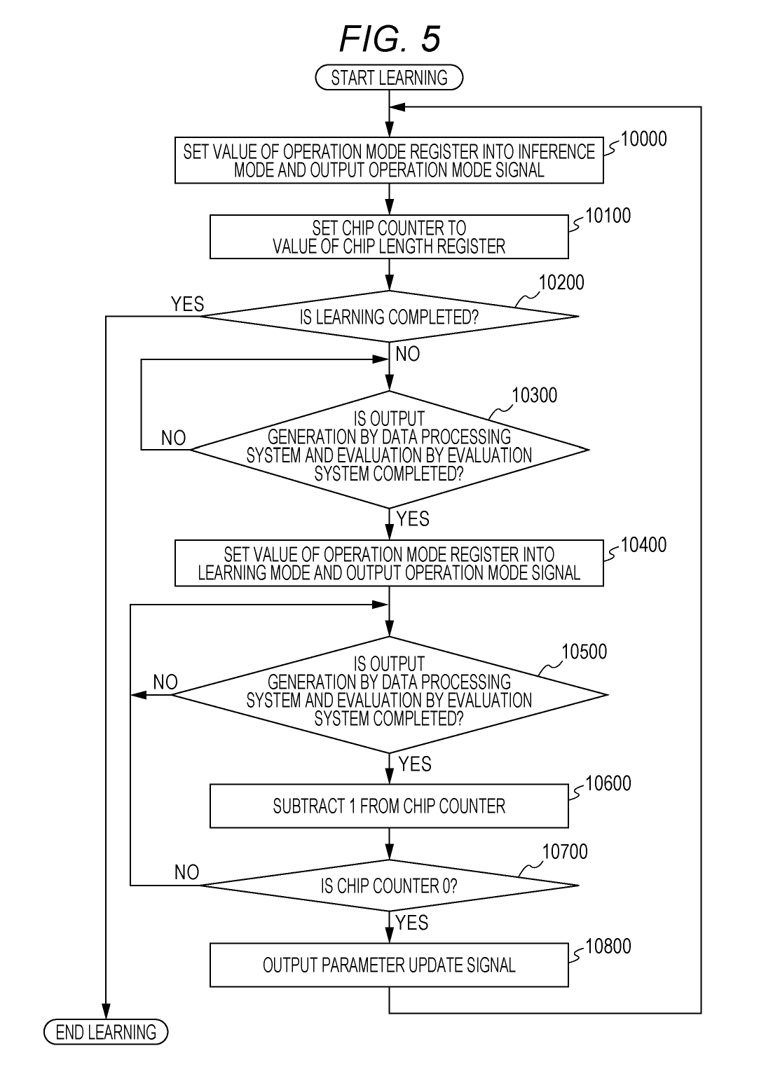

In the present embodiment, the learning mode is performed once or more with respect to the inference mode performed once. That is, a reference cost value is initially acquired in the inference mode, and a learning mode of generating a numerical number by each of a plurality of number generators, performing data processing by using values in which these numerical numbers are respectively added to a plurality of parameters, acquiring a current cost value by the evaluation system, and calculating a gradient value necessary for a parameter update by using a cost value difference and the generated numerical numbers is subsequently performed once or more. Subsequently, the sum of the above-described one or more gradient values calculated in the learning mode is calculated at timing of switching back to the inference mode, a value in which the sum is divided by the number of times of executions of the learning mode is added to a parameter, and the parameter is updated. This can be easily understood from an operation description with reference to FIG. 5.

FIG. 5 is an operation flowchart of the control unit 1300.

It is assumed that a value of the chip length register and a learning completion criterion (number of learning cycle until termination in case where target cost value and cost value do not vary) are previously given to the control unit by an operator of the present system before learning is started.

(10000) A value of the operation mode register 1310 is set to be a value indicating the inference mode and an operation mode signal is output.

(10100) A value of the chip length register 1320 is set in the chip counter 1330.

(10200) The learning completion determination unit 1340 determines completion of learning according to a cost value.

In a case where it is determined that the learning is completed, the flowchart is not followed anymore and the operation is stopped. In a case where it is determined that the learning is not completed yet, the operation goes to a procedure (10300).

(10300) The data processing system 1000 generates an output result from data set in the input register 1100 and stands by until evaluation by the evaluation system is completed. In this standby period, a cost value with respect to a result of applying processing to current input data by the data processing system is calculated and written into the reference cost value register 1420.

The procedure (10300) is repeated until the completion.

(10400) A value of the operation mode register 1310 is set to be the learning mode and an operation mode signal is output.

(10500) The data processing system 1000 generates an output result from data set in the input register 1100 and stands by until evaluation by the evaluation system is completed. The procedure (10500) is repeated until the completion.

(10600) 1 is subtracted from a value of the chip counter 1330.

(10700) The operation goes to a procedure (10800) in a case where the value of the chip counter 1330 is 0.

The operation goes to a procedure (10500) in a case other than 0.

(10800) A parameter update signal is output. The operation goes to a procedure (10000).

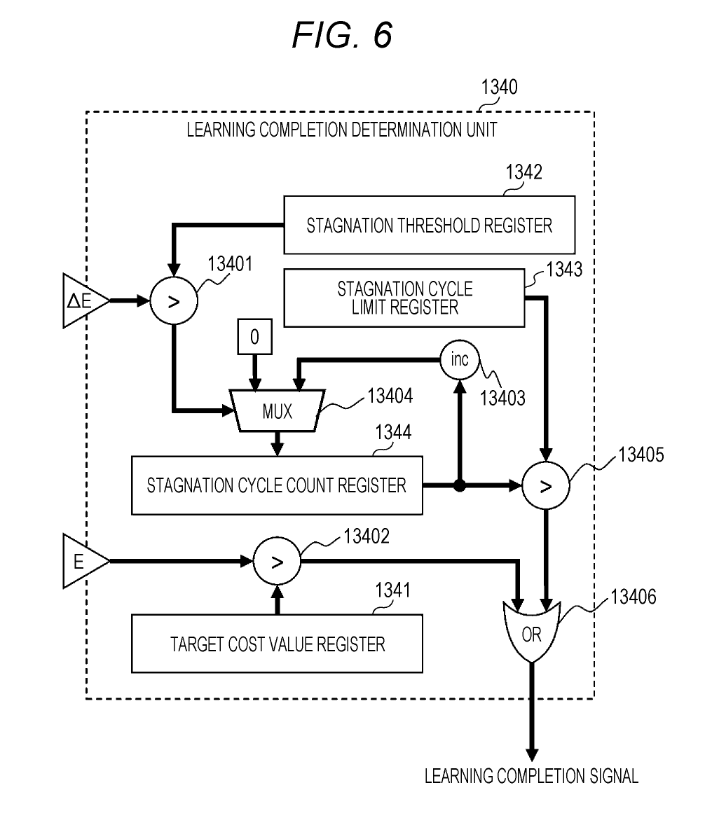

FIG. 6 is a view illustrating a configuration of the learning completion determination unit 1340.

The learning completion determination unit 1340 includes a target cost value register 1341, a stagnation threshold register 1342, a stagnation cycle limit register 1343, a stagnation cycle count register 1344, and a peripheral circuit. A cost value E given from the outside is input into the target cost value register 1341 and a cost value comparator 13402, and a positive signal is output in a case where a current cost value is larger or smaller than a target value. An absolute value of a cost difference ΔE is input into the stagnation threshold register 1342 and a difference comparator 13401, and a positive signal is output in a case where the absolute value of the cost difference is smaller than a value of the stagnation threshold register 1342. A value of the stagnation cycle count register 1344 is updated via a selector 13404 by an output of the difference comparator 13401 each time evaluation by the evaluation system is completed.

That is, the stagnation cycle count register 1344 is updated by a value to which 1 is added by an adder 13403 in a case where an output of the difference comparator 13404 is positive, and is updated by 0 in a case where the output is negative. An output of the stagnation cycle limit register 1343 and an output of the stagnation cycle count register 1344 are input into a stagnation cycle comparator 13405, and a positive signal is output in a case where a value of the stagnation cycle count register 1344 is equal to or larger than a value of the stagnation cycle limit register 1343. Outputs of the cost value comparator 13402 and the stagnation cycle comparator 13405 are input into an OR gate 13406, and a learning completion signal is transmitted to the outside when one of these transmits a positive signal.

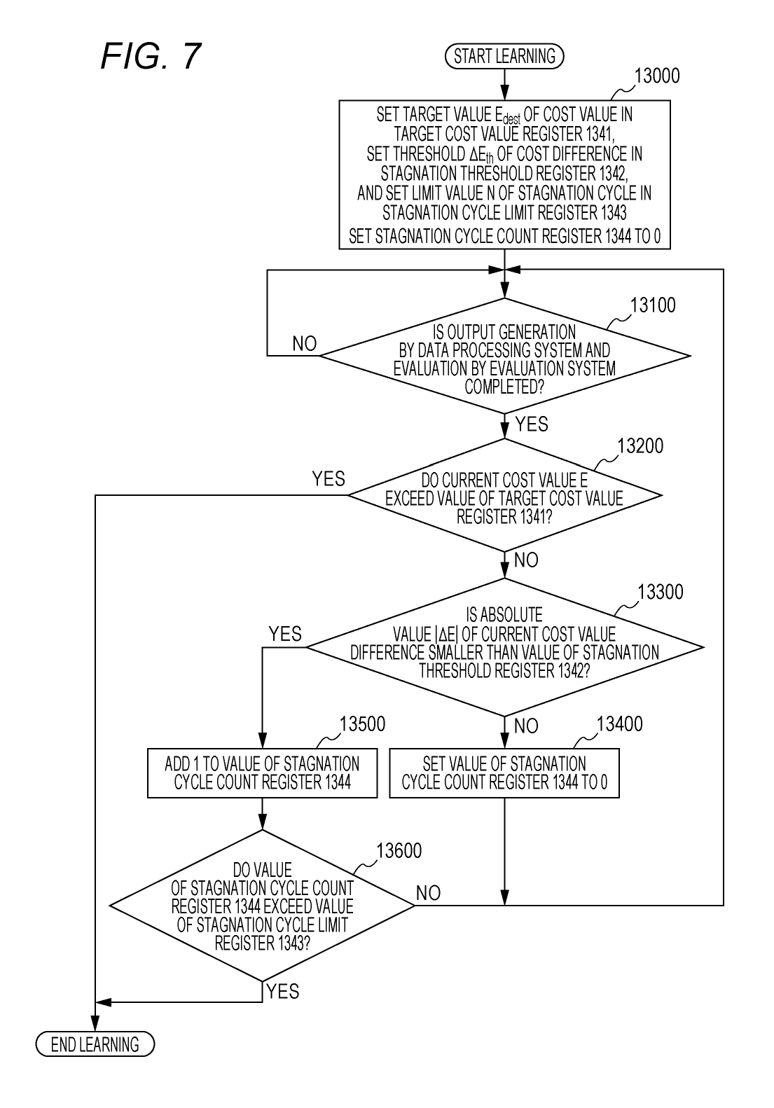

Next, an operation procedure will be described with reference to an operation flowchart of the learning completion determination unit 1340 in FIG. 7.

(13000) A target value E_{dest} of a cost value given from the outside is set in the target cost value register 1341, a threshold ΔEₜₕ of a cost difference is set in the stagnation threshold register 1342, and a limit value N of a stagnation cycle is set in the stagnation cycle limit register 1343.

The stagnation cycle count register 1344 is set to 0.

(13100) A procedure (13100) is repeated until output generation by the data processing system and evaluation by the evaluation system are completed. When the evaluation is completed, the operation goes to a procedure (13200).

(13200) In determination whether a current cost value E exceeds the target value E_{dest} set in the target cost value register 1341, it is determined that the learning is completed in a case where the current cost value E exceeds the target value E_{dest}. In a case where the target value E_{dest} is not exceeded, the operation goes to a procedure (13300). Here, “exceeding” means “becoming smaller” in a case where minimization of a cost value is an object, and means “becoming larger” in a case where maximization of a cost value is an object.

(13300) In determination whether an absolute value |ΔE| of a current cost value difference is smaller than a value of the stagnation threshold register 1342, the operation goes to a procedure (13500) in a case where the absolute value |ΔE| of the current cost value difference is equal to or smaller than the threshold ΔEₜₕ. In a case where the absolute value |ΔE| is larger than the threshold, the operation goes to a procedure (13400).

(13400) A value of the stagnation cycle count register 1344 is set to 0. The operation goes to the procedure (13100).

(13500) 1 is added to the value of the stagnation cycle count register 1344.

(13600) In a case where the value of the stagnation cycle count register 1344 exceeds the value of the stagnation cycle limit register 1343, it is determined that the learning is completed. In a case where the value is not exceeded, the operation goes to the procedure (13100).

Note that in a case where it is determined that the learning is completed, the chip length register 1320 is reset to 0 and it is indicated that learning completion determination is made. Alternatively, a notice of learning completion may be given to the outside by different means.

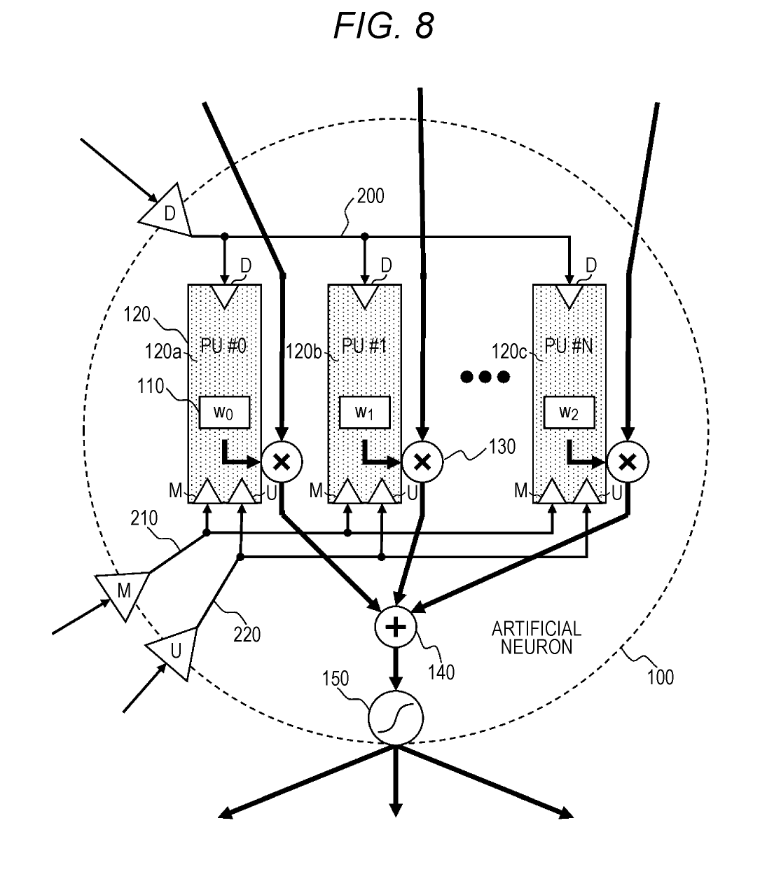

FIG. 8 is a view illustrating a configuration of the activation state decision unit 100.

The activation state decision unit 100 includes one or more parameter units 120, a multiplier 130 that calculates a product of an output of a parameter unit and an input into the activation state decision unit, an adder 140 that adds outputs of a plurality of multipliers 130, and an activation function device 150 that decides an activation state of the activation state decision unit on the basis of an output result of the adder. To each of a plurality of parameter units 120 in the activation state decision unit 100, the cost difference broadcast path 200, the operation mode broadcast path 210, and the parameter update signal broadcast path 220 are connected.

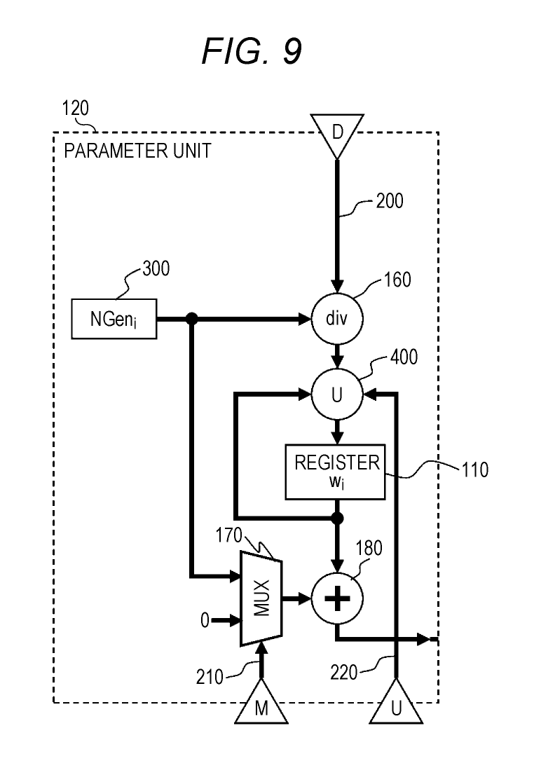

FIG. 9 is a view illustrating a configuration of a parameter unit 120.

The parameter unit 120 includes a parameter register 110, a number generator 300, a parameter updating unit 400, and a peripheral functional block. As an input, the cost difference broadcast path 200, the operation mode broadcast path 210, and the parameter update signal broadcast path 220 are connected to the parameter unit 120. A parameter value is output to the outside. An output of the number generator 300 is input into the selector 170 that can be switched according to an operation mode. The selector 170 outputs 0 in a case of the inference mode, and outputs a value generated by the number generator 300 in a case of the learning mode. An output value from the selector 170 and a value of the parameter register 110 are added to each other by a number processor such as the adder 180 and output to the outside. Also, a difference input from the cost difference broadcast path 200 is divided by an output of the number generator 300 by a divider 160, whereby an estimated gradient value is calculated and input into the parameter updating unit 400. By using the estimated gradient value and a current value of the parameter register 110, the parameter updating unit 400 updates the value of the parameter register 110 when an update signal from the parameter update signal broadcast path 220 is received.

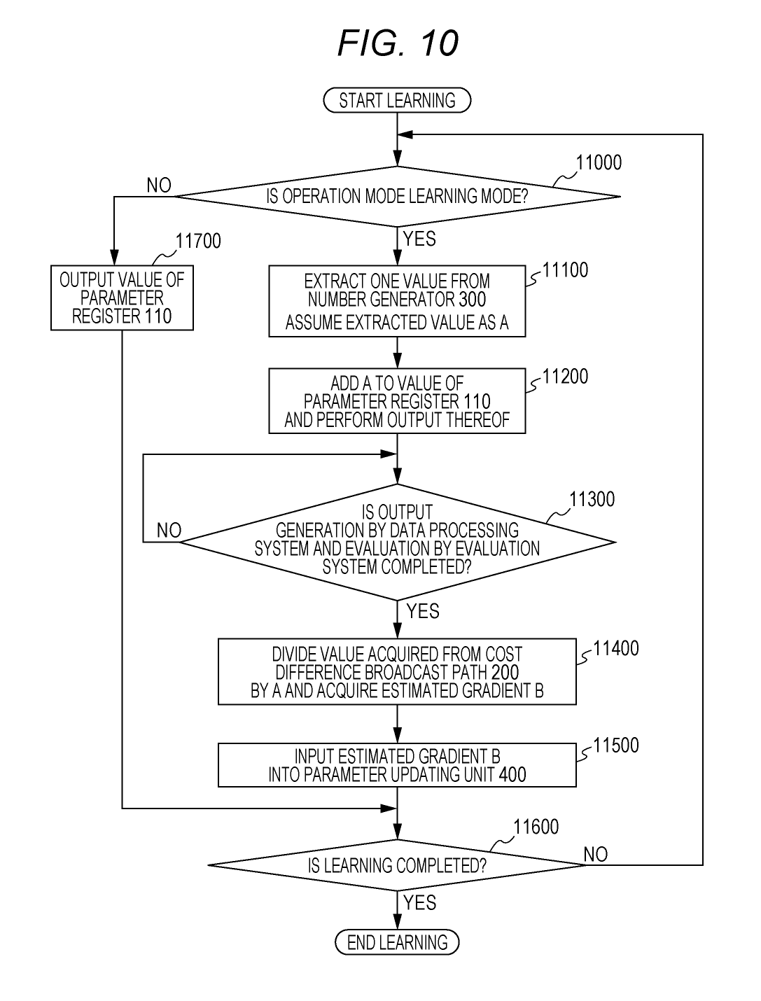

Next, an operation procedure will be described with reference to an operation flowchart of the parameter unit 120 in FIG. 10.

(11000) In a case where an operation mode is the learning mode in determination of the operation mode, the operation goes to a procedure (11100). In a case where the operation mode is the inference mode, the operation goes to a procedure (11700).

(11100) One value is extracted from the number generator 300. The extracted value is referred to as A in the following.

(11200) A is added to a value of the parameter register 110 and an output thereof is performed.

(11300) By processing using current input data and a parameter output in the procedure (11200), an output of the data processing system is generated and standby is performed until evaluation thereof is performed by the evaluation system and a cost value is calculated. The cost value is input into the current cost value register 1410, and a difference from a value of the reference cost value register 1420 is calculated by the cost difference calculator 1400 and broadcasted to the parameter unit through the cost difference broadcast path 200.

(11400) The value broadcasted from the cost difference broadcast path 200 is divided by A and an estimated gradient value B is calculated.

(11500) The estimated gradient value B is input into the parameter updating unit 400.

(11600) When learning is not completed, the operation goes to the procedure (11000). The operation is ended in a case where learning is completed.

(11700) A value of the parameter register 110 is output to the outside. The operation goes to the procedure (11600).

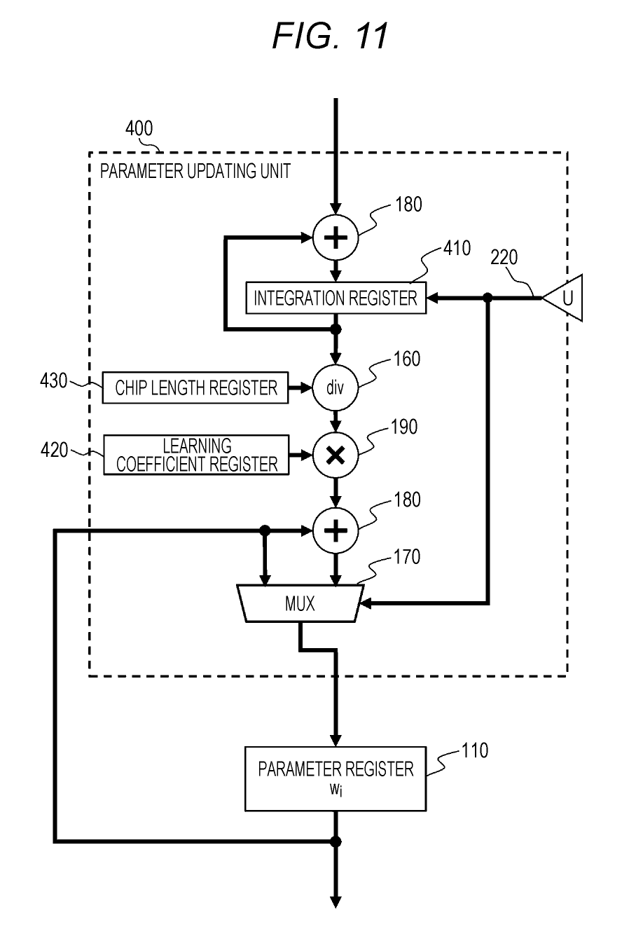

FIG. 11 is a view illustrating a configuration of the parameter updating unit 400.

The parameter updating unit 400 includes an integration register 410, a learning coefficient register 420, and a chip length register 430. The parameter updating unit 400 receives an estimated gradient value calculated in the parameter unit 120, a current value of the parameter register 110, and a signal from the parameter update signal broadcast path 220 from the outside and outputs a signal to update the value of the parameter register 110. In a period in which no parameter update signal is received, the adder 180 adds an estimated gradient value to a value in the integration register 410. The selector 170 is set to use a current value of the parameter register 110 for an update of the parameter register 110, and an update is not practically performed. In a case where a parameter update signal is received, a value in which a current value of the parameter register 110 is added by the adder 180 to a value of the integration register 410 which value is divided by a value of the chip length register 430 by the divider 160 and is further multiplied by a value of the learning coefficient register 420 by a multiplier 190 is calculated. The value of the parameter register 110 is updated by the added value. Also, the value of the integration register is reset to 0.

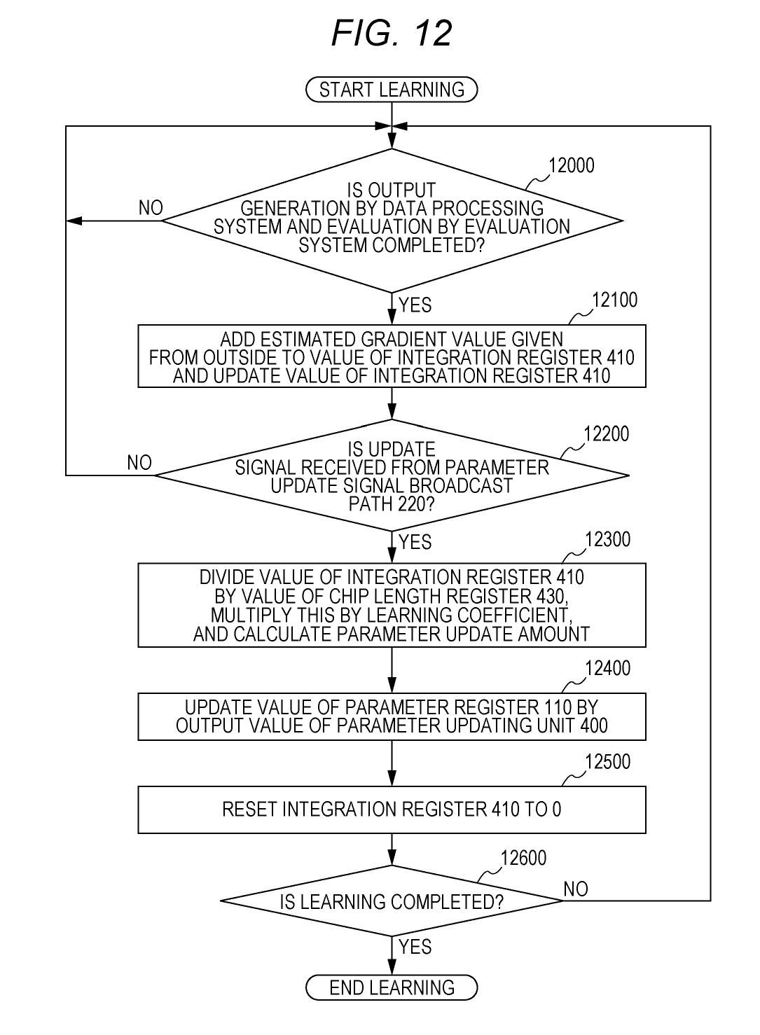

Next, an operation procedure will be described with reference to an operation flowchart of the parameter updating unit in FIG. 12.

(12000) When output generation by the data processing system and evaluation by the evaluation system are not completed, standby is performed until output generation by the data processing system and evaluation by the evaluation system are completed, a cost difference is broadcasted to the parameter unit 120, and an estimated gradient is calculated. The procedure (12000) is repeated until an estimated gradient value is given.

(12100) An estimated gradient value calculated in the parameter unit 120 is added to a current value of the integration register 410 and the value of the integration register 410 is updated.

(12200) In a case where an update signal is received from the parameter update signal broadcast path 220, the operation goes to the procedure (12300). In a case where the update signal is not received, the operation goes to the procedure (12000).

(12300) A value of the integration register 410 is divided by a value of the chip length register 430 and the estimated gradient value is corrected. A parameter update amount is calculated by multiplication of a corrected result by a learning coefficient.

(12400) The parameter update amount and a current value of the parameter register 110 are added to each other and the value of the parameter register 110 is updated with a calculation result.

(12500) The value of the integration register 410 is reset to 0.

(12600) In a case where learning is completed, the flowchart is not followed anymore and the operation is stopped. In a case where learning is not completed, the operation goes to the procedure (12000).

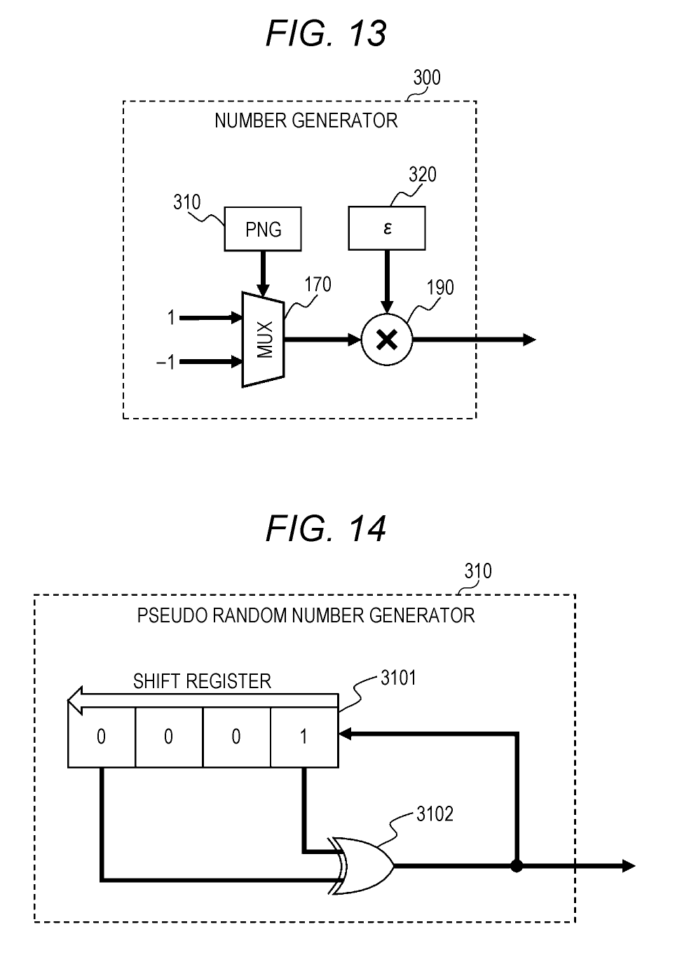

FIG. 13 is a view illustrating a configuration of the number generator 300.

The number generator 300 includes a pseudo noise source (or pseudo random number source) 310, a small number generator for numerical number derivation 320, a selector 170 that generates a positive or negative sign according to an output of the number generator 300, and a multiplier 190 that calculates a product of an output of the selector 170 and a numerical number of the small number generator for numerical number derivation 320 and that performs an output thereof. The number generator 300 generates and outputs any one of positive and negative small numerical numbers according to a request. The small number generator for numerical number derivation 320 may be mounted in such a manner as to constantly generate a constant number by utilization of a numerical number storing register.

FIG. 14 is a view illustrating a configuration of the pseudo noise source 310.

The pseudo noise source 310 has a property in which correlativity of vectors of the same phase is higher than correlativity of vectors of different phases. In other words, a value acquired by multiplication and integration of vectors of different phases is dominantly smaller than a value acquired by multiplication and integration of vectors of the same phase.

More specifically, the pseudo noise source 310 includes a shift register 3101 and an exclusive-OR operation device 3102. A value at a specific position of the shift register 3101 is input into the exclusive-OR operation device 3102 (hereinafter, referred to as “tap”), a calculation result is output and input into a first stage of the shift register, and a state of the shift register is updated. Note that an output may be performed from the last stage of the shift register. A length and a tap position of the shift register are decided according to a primitive polynomial. When a length of the shift register is N, a pseudo noise generated in such a circuit is called an N stage M sequence pseudo noise. The N stage M sequence pseudo noise has a cycle of T=2^{N}−1 and has a property that the number of times of appearance of 0 and that of 1 are nearly equal. Also, in a case where 0 and 1 are assigned to −1 and +1, a correlation value of a case where initial values of the shift register (hereinafter, referred to as phase) are equal becomes 1, and a correlation value of a case where phases are different becomes −1/N. Since integration of signals emitted from noise sources of different phases becomes asymptotic to 0 when N is sufficiently large, an influence other than that of a parameter a value of which is changed according to noise sources of the same phase can be eliminated.

From the above description, it is understood that the parameter unit 120 updates, with respect to one piece of input data, values of internal parameters by simultaneously changing the values of the internal parameters and performing integration of a variation of a cost value on the basis of an output of the number generator 300 including the pseudo random number generator 310, and performs machine learning by updating the values of the internal parameters each time input data is changed.

Note that the number generator may be a random number generator. However, with the random number generator, it is not secured that correlation between parameter units is sufficiently low. Thus, with a pseudo random number generator that changes cyclically being used as a number generator, correlation between parameter units can be sufficiently low and the number of processes necessary for learning can be decreased.

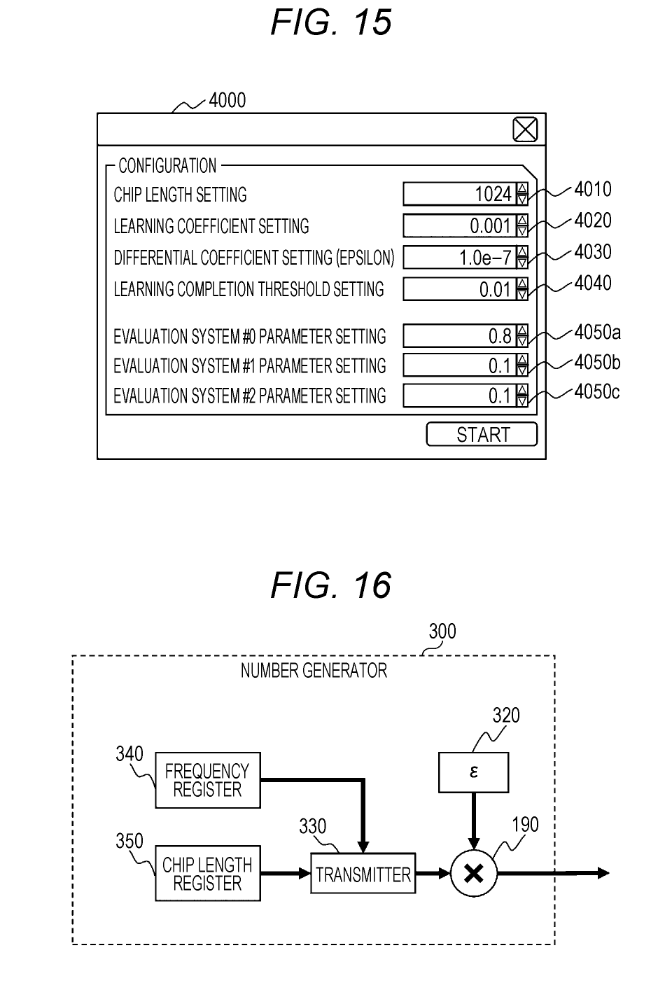

FIG. 15 is a view illustrating an example of a setting screen of a learning condition in a machine learning system.

The setting screen is displayed on a display unit that is one of input/output devices 3040 of a calculator 3000 (FIG. 3) included in the data processing system 1000.

The setting screen 4000 includes items that are a chip length setting 4010, a learning coefficient setting 4020, a differential coefficient setting 4030, a learning completion threshold setting 4040, and an evaluation system parameter setting 4050. The chip length setting 4010 is a value indicating a cycle of learning and is reflected on the chip length register 1320 of the control unit 1300, and the chip length register 430 of the parameter updating unit. A value of the learning coefficient setting 4020 is reflected on the learning coefficient register 420 of the parameter updating unit 400. A value of the differential coefficient setting 4030 is reflected on the small number generator for numerical number derivation 320 of the number generator 300. The learning completion threshold setting 4040 is used by the learning completion determination unit 1340 of the control unit 1300 to determine learning completion. The evaluation system parameter setting 4050 is reflected on the cost value parameter register 1500 of the data processing system 1000.

Note that major setting items are listed in the illustrated example. However, in addition to these, there may be a setting parameter corresponding to a register at an arbitrary position in the present embodiment. Also, a graphical user interface is included in this example. However, an interface in which command based setting is performed may be included.

### Second Embodiment

The second embodiment indicates a different configuration example of a number generator 300.

FIG. 16 is a view illustrating a configuration of a number generator 300 according to the second embodiment. The number generator 300 includes a transmitter 330, a frequency register 340, a chip length register 350, a small number generator for numerical number derivation 320, and a multiplier 190. The transmitter 330 generates a signal on the basis of values of the frequency register 340 and the chip length register 350. The multiplier 190 multiplies an output of the transmitter 330 and a numerical number of the small number generator for numerical number derivation 320 and performs an output thereof to the outside.

When the values of the frequency register 340 and the chip length register are respectively F and T, the transmitter 330 generates a numerical sequence that follows the following Formula 8 and that can be considered as a discrete sine wave in a cycle T.

$$[ Mathematical Formula 8 ]$$

$${C}_{F} = \{ {C}_{F} ( t ) \text{:} sin 2 \frac{t}{T} F π \} \qquad Formula 8$$

A phase of the number generator in the second embodiment corresponds to the value F of the frequency register, different values being respectively set for parameter units.

When values of frequency registers 340 of two different number generators 300 in the second embodiment are F_{N} and F_{M}, the following relationship is established.

$$[ Mathematical Formula 9 ]$$

$${\int }_{0}^{2 π} sin 2 {tF}_{N} \cdot sin 2 {tF}_{M} dt = \{ \begin{matrix}1 if {F}_{N} = {F}_{M} \\ 0 if {F}_{N} \neq {F}_{M}\end{matrix} \qquad Formula 9$$

When this is discretized, the following Formula 10 is acquired.

$$[ Mathematical Formula 10 ]$$

$${\sum }_{t = 0}^{T} sin 2 \frac{t}{T} {F}_{N} π \cdot sin 2 \frac{t}{T} {F}_{M} π = \{ \begin{matrix}1 if {F}_{N} = {F}_{M} \\ 0 if {F}_{N} \neq {F}_{M}\end{matrix} \qquad Formula 10$$

In such a manner, since convergence into 1 is performed in a case of the same phase and convergence into 0 is performed in a case of different phases, an operation similar to that of the first embodiment can be performed by utilization of a numerical sequence generated by the number generator 300 of the present embodiment.

### Third Embodiment

The third embodiment indicates a different configuration example of a parameter updating unit 400.

In an embodiment of the present invention, by processing using correlativity of number generators 300, an influence quantity of parameter units 120 of the same phase on an output of a data processing system is separated from an influence quantity of parameter units 120 of different phases. When one learning cycle is from a start to an end of a learning mode, it can be expected that the influence quantity of the parameter units of different phases is observed as a random noise. On the other hand, in a case where a parameter value is gradually updated in each learning cycle, it can be expected that a variation of a gradient is gradual.

In order to reduce a random noise by using this assumption, a filter circuit 440 such as a lowpass filter is added to a parameter updating unit 400 and an estimated gradient value is calculated. The filter circuit extracts, from a random noise existing regardless of a frequency region, a temporal variation signal of a gradient that is expected to be in a low frequency region.

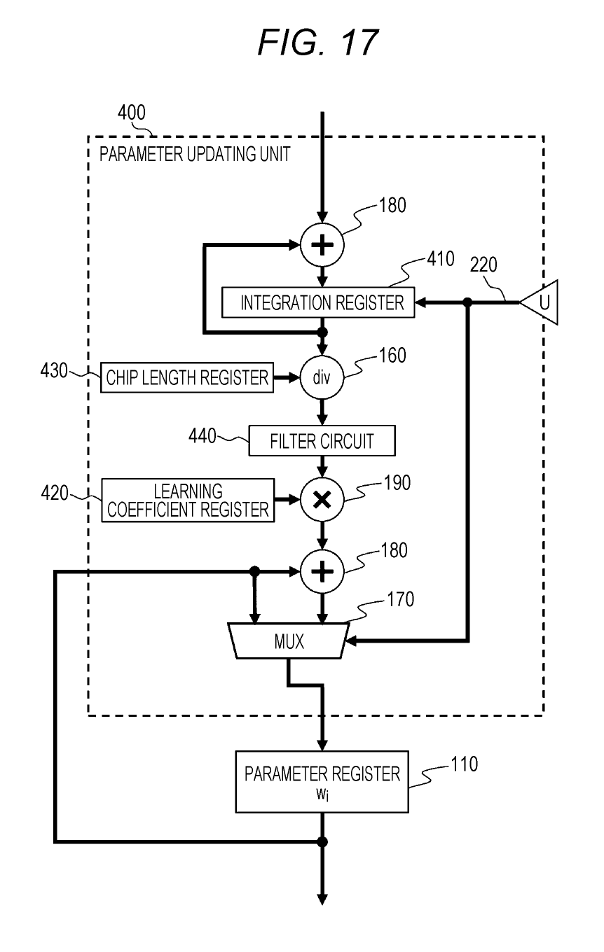

FIG. 17 is a view illustrating a configuration of the parameter updating unit 400 in the third embodiment. A point different from the parameter updating unit 400 in the first embodiment (FIG. 11) is that a filter circuit 440 is arranged in a following stage of a divider 160. After a value of an integration register 410 is divided by a value of a chip length register 430 by the divider 160, a temporal variation signal of a gradient in a low frequency region is extracted in the filter circuit 440, an output of the filter circuit 440 and a value of a learning coefficient register 420 are multiplied by each other in a multiplier 190, and an estimated gradient value is acquired. Since other parts are similar to those of the first embodiment, a description thereof is omitted.

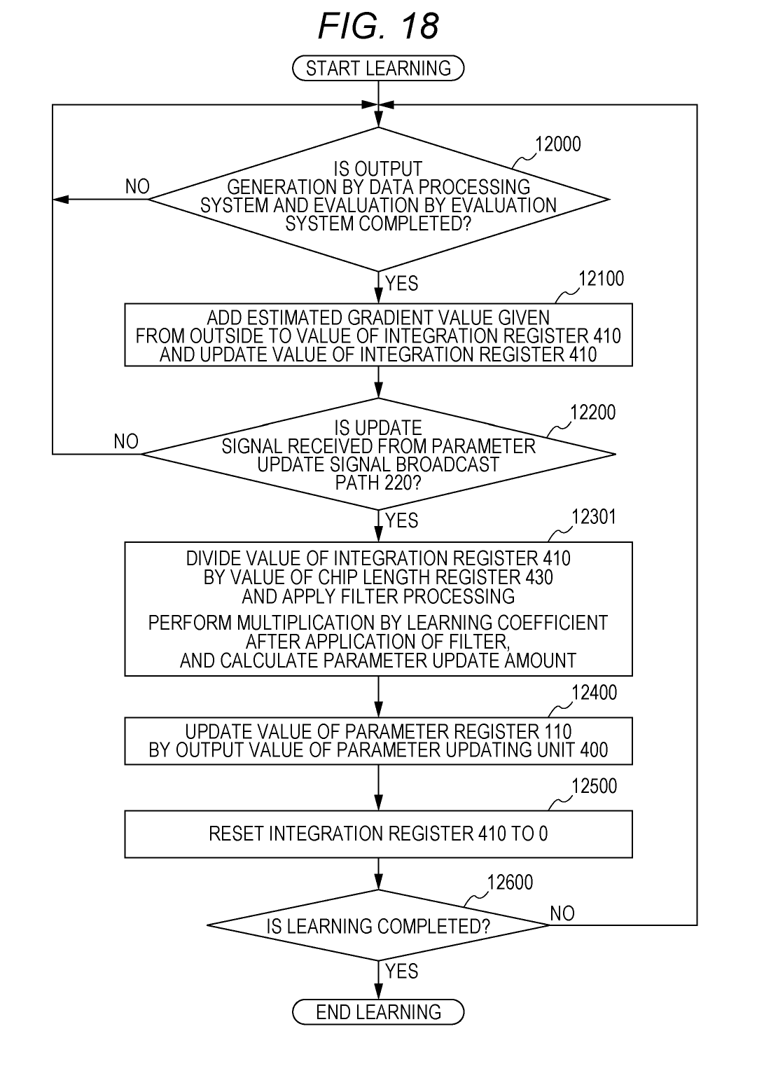

An operation procedure of the parameter updating unit 400 in the third embodiment will be described with reference to an operation flowchart illustrated in FIG. 18. A procedure (12300) in the first embodiment (see FIG. 12) is modified to the following procedure (12301).

(12301) A value of the integration register 410 is divided by a value of the chip length register 430 and input into the filter circuit 440. An output of the filter circuit is multiplied by a learning coefficient, and a parameter update amount is calculated.

Since what is other than the above procedure (12300) is similar to that of the first embodiment (FIG. 12), a description thereof is omitted.

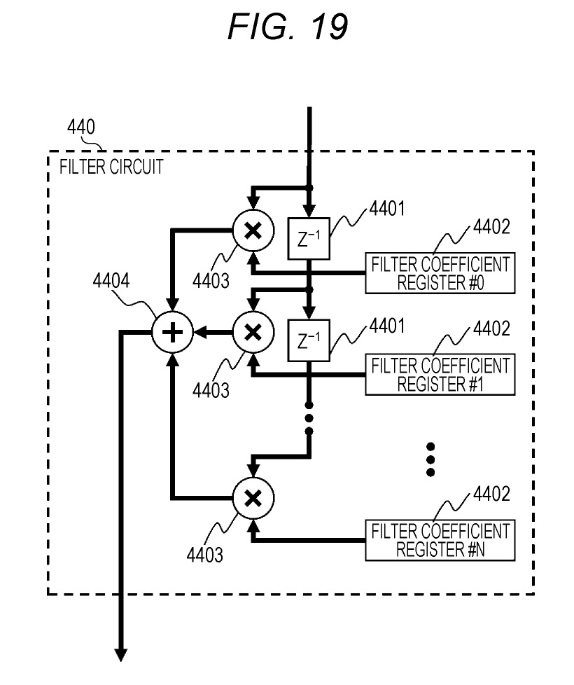

A configuration of the filter circuit 440 is illustrated in FIG. 19.

The filter circuit 440 includes one or more delay elements 4401, a plurality of filter coefficient registers 4402 that holds filter coefficients multiplied by outputs of the delay elements, a plurality of multipliers 4403 that respectively multiplies the outputs of the delay elements 4401 and the coefficients of the filter coefficient registers 4402, and an adder 4404 that adds the values multiplied by the multipliers 4403. An output of the adder 4404 is an output of the filter circuit 440.

Note that a typical FIR filter configuration is illustrated in the example in the drawing. However, an IIR filter may be included. A value of a filter coefficient is adjusted in such a manner that a function as a lowpass filter is performed. A cutoff frequency can be adjusted according to a condition of a gradient variation, and is set according to a variation tendency of a cost value of an evaluation system.

### Fourth Embodiment

In a machine learning system, a setting of a chip length influences gradient estimation accuracy and progress of learning. Thus, when it is determined that progress of learning is sluggish, there is a possibility that learning can be further advanced by increasing of a chip length before it is determined that learning is completed. In the fourth embodiment, a part of a configuration and an operation of a control unit 1300 and a learning completion determination unit 1340 is modified.

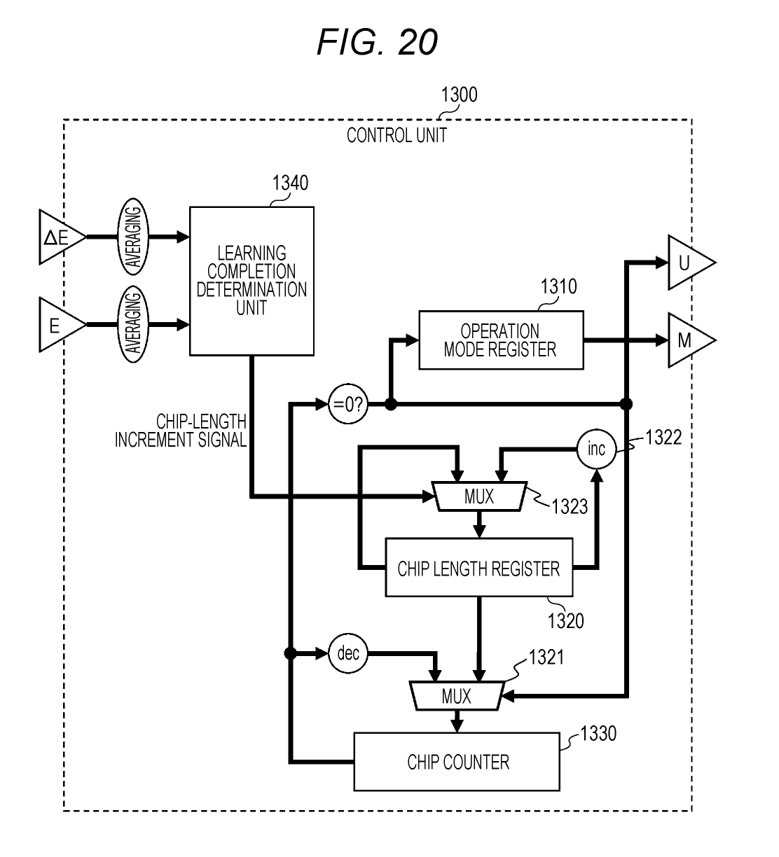

FIG. 20 is a view illustrating a configuration of the control unit 1300. Peripheral circuits such as an adder 1322, which adds a value of a chip length register 1320 on the basis of a chip-length increment signal from a learning completion determination unit 1340, and a selector 1323 are added in a periphery of the chip length register 1320. In a case where the chip-length increment signal is not transmitted, a value of the chip length register 1320 is held as it is.

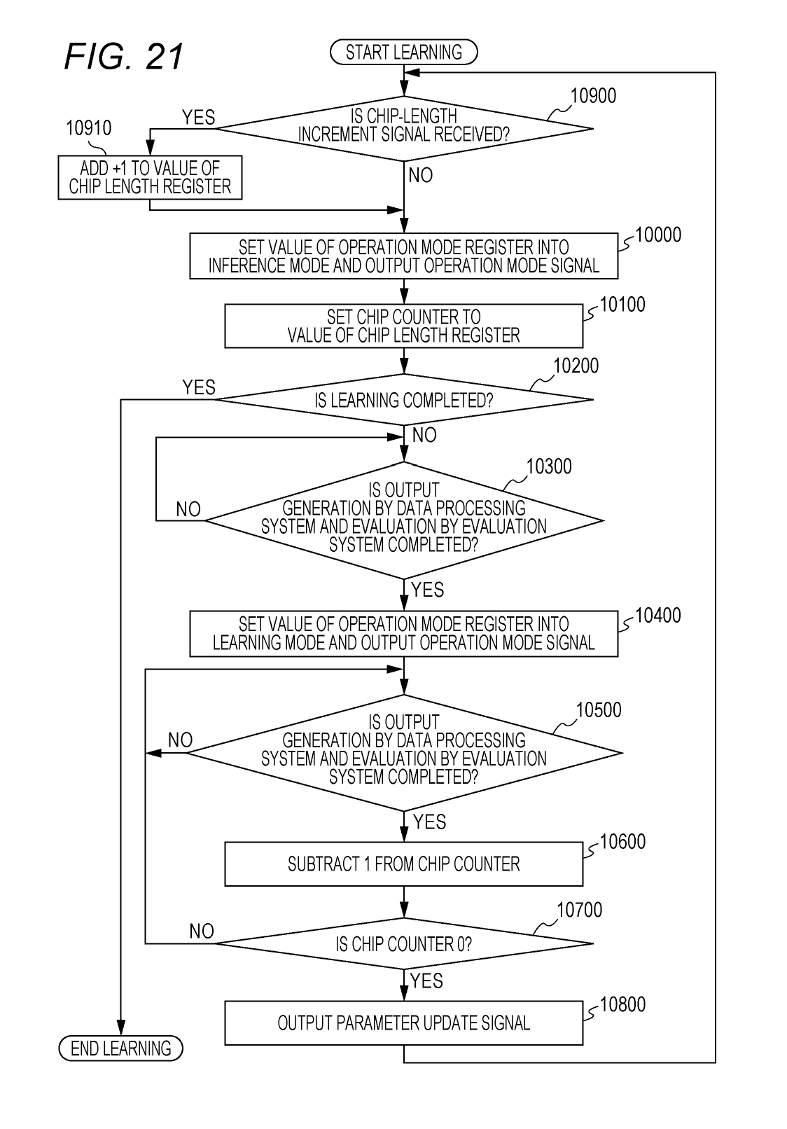

An operation flowchart of the control unit 1300 is illustrated in FIG. 21. The same sign is assigned to a procedure identical to an operation of the control unit in the first embodiment (flowchart in FIG. 5). In the fourth embodiment, step 10900 and step 10910 are added to the operation in FIG. 5. In the following, an added characteristic operation will be described. Note that learning is started from a procedure (10900).

(10800) A parameter update signal is output. The operation goes to the procedure (10900).

(10900) In a case where a chip-length increment signal is received from the learning completion determination unit 1340, the operation goes to a procedure (10910). In a case where the signal is not received, the operation goes to a procedure (10000).

(10910) +1 is added to a value of the chip length register. The operation goes to a procedure (10000).

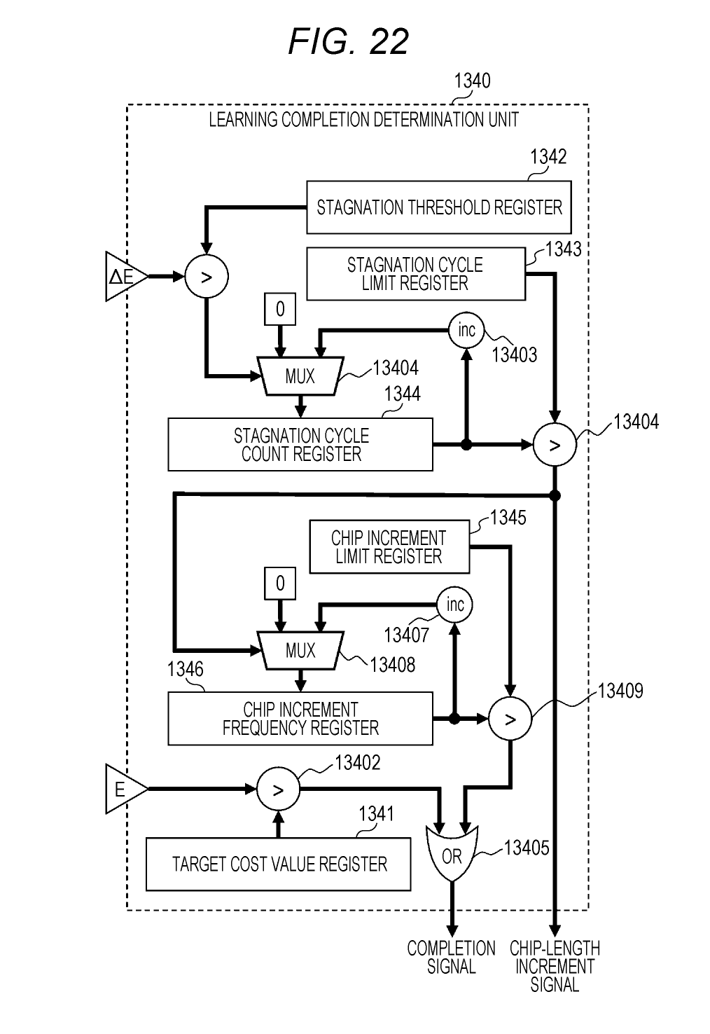

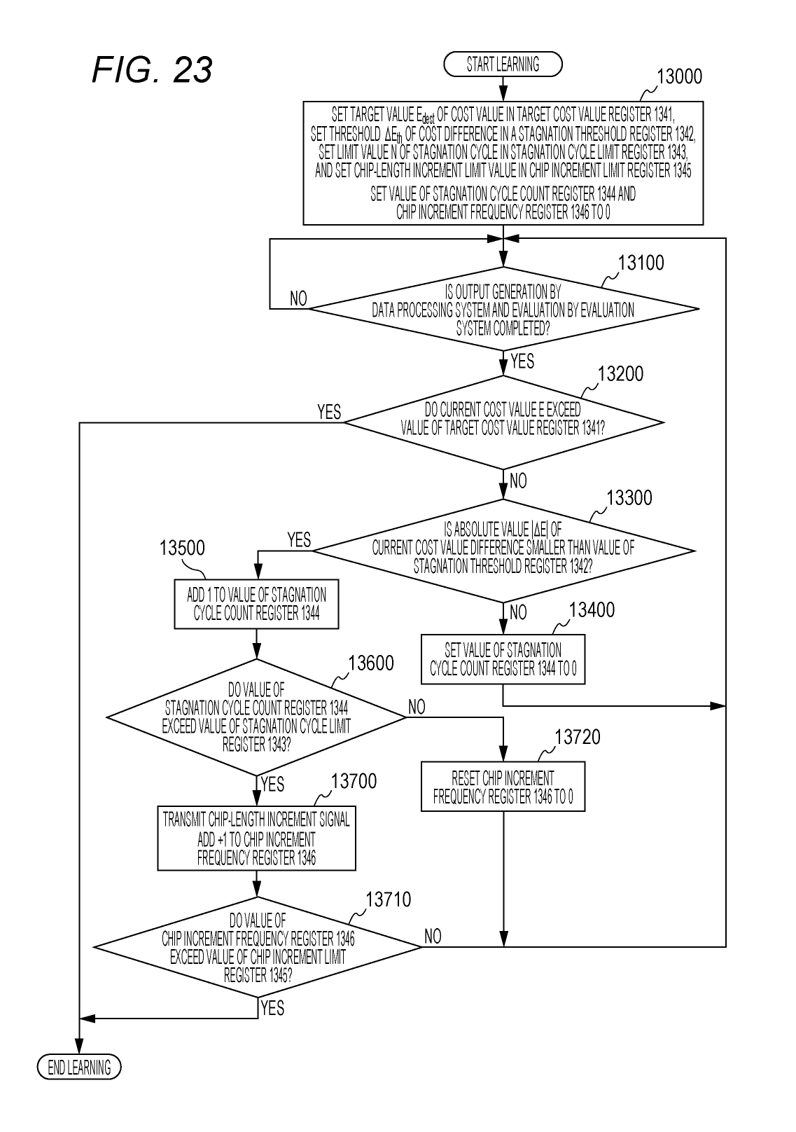

FIG. 22 is a view illustrating a configuration of the learning completion determination unit 1340.

The learning completion determination unit 1340 includes a configuration of the learning completion determination unit 1340 of the first embodiment (FIG. 6) to which configuration a chip increment limit register 1345, a chip length increment frequency register 1346, and a peripheral circuit are added. In the first embodiment, an update in performed in such a manner that a learning completion signal is transmitted when a variation amount of a cost value is smaller than a threshold for a certain period. On the other hand, in the fourth embodiment, in a case where a variation amount is smaller than a threshold for a certain period, a signal of incrementing a chip length is transmitted, and “1” is added to the chip length increment frequency register 1346 via an adder 13407 and a selector 13408. In a case where the variation amount is kept smaller than the threshold even when a chip length is incremented and it is determined by a comparator 13409 that a value of the chip length increment frequency register 1346 exceeds a value of the chip increment limit register 1345, a learning completion signal is generated. OR 13406 of the generated signal and a signal from a cost value comparator 13402 is acquired and output to the outside. On the other hand, in a case where a cost difference exceeds a threshold in a cycle following a cycle in which a chip length is incremented in the comparator 13409, a value of the chip length increment frequency register 1346 is reset to “0.”

An operation procedure of the learning completion determination unit 1340 will be described with reference to an operation flowchart in FIG. 23. An operation of a part different from that of the first embodiment will be described in the following.

(13600) In a case where a value of a stagnation cycle count register 1344 exceeds a value of a stagnation cycle limit register 1343, the operation goes to a procedure (13700). In a case where the value is not exceeded, the operation goes to a procedure (13720).

(13700) A chip-length increment signal is transmitted. Also, +1 is added to the chip length increment frequency register 1346.

(13710) In a case where a value of the chip length increment frequency register 1346 becomes larger than a value of the chip increment limit register 1345, an operation flow is not followed anymore and a state transitions to a learning completion state. In a case where the value is smaller than the limit, the operation goes to a procedure (13100).

(13720) A value of the chip length increment frequency register 1346 is reset to “0.”

The operation goes to the procedure (13100).

As described above, according to preferred embodiments of the present invention, a problem in which definition of an mathematical formula of a cost function is difficult or a cost function formula is non-differentiable and to which back propagation can be hardly applied can be solved. Also, in a neural network of a scale in which gradient estimation with a realistic calculation amount is difficult in numerical differentiation, a calculation amount can be reduced to a realistic scale.

What is claimed is:

1. A machine learning system comprising:
an activation state decision unit that changes data on the basis of a parameter and that processes and outputs the data,
wherein the activation state decision unit includes a plurality of parameter units that is made to process the data on the basis of parameters respectively managed thereby,
each of the plurality of parameter units includes
a number generator that generates a numerical number a sign of which varies,
a number processor that creates a parameter to process the data on the basis of the parameter and the numerical number generated by the number generator, and
a parameter updating unit that updates the parameter on the basis of a cost value, which is acquired by evaluation of the processed data by an evaluation system, and the numerical number generated by the number generator, and
the number generator changes the generated numerical number in each data processing, and generates the numerical number in such a manner that order of a sign variation of the numerical number varies between the parameter units.

2. The machine learning system according to claim 1, wherein the number generator includes a random number generator that generates a numerical number with a different sign.

3. The machine learning system according to claim 2, wherein the random number generator of the number generator is a pseudo random number generator in which a generated numerical number is changed cyclically, and
the pseudo random number generator is set in such a manner that order of a sign variation varies between the parameter units.

4. The machine learning system according to claim 1, wherein an absolute value of the numerical number generated by the number generator is not constant,
the number processor uses a value acquired by addition of the numerical number to the parameter, and
the parameter updating unit uses a value acquired by division of the cost value by the numerical number.

5. The machine learning system according to claim 1, wherein a parameter for the update is created in a state in which the numerical number generated by the number generator is fixed, and
the numerical number generated by the number generator is updated in a case where the parameter is updated.

6. The machine learning system according to claim 1, further comprising
a control unit that controls, by an operation mode, a learning mode of performing the data processing by using the numerical number generated by the number generator and an inference mode of performing the data processing without using the numerical number,
wherein the control unit
stores, as a reference cost value, a cost value evaluated by an evaluation system in the inference mode, and
transmits a difference, which is acquired by comparison between a cost value evaluated by the evaluation system in the learning mode and the reference cost value, to the parameter units as a cost value to update the parameter.

7. The machine learning system according to claim 6, wherein in a case where the learning mode and the inference mode are changed, the parameter is updated.

8. The machine learning system according to claim 1, wherein the activation state decision unit is included in an artificial neuron.

9. A machine learning method in a machine learning system including an activation state decision unit that changes data on the basis of a parameter and that processes and outputs the data,
wherein the activation state decision unit includes a plurality of parameter units that is made to process the data on the basis of parameters respectively managed thereby,
each of the plurality of parameter units includes
a number generator that generates a numerical number a sign of which varies,
a number processor that creates a parameter to process the data on the basis of the parameter and the numerical number generated by the number generator, and
a parameter updating unit that updates the parameter on the basis of a cost value, which is acquired by evaluation of the processed data by an evaluation system, and the numerical number generated by the number generator, and
the number generator changes the generated numerical number in each data processing, and generates the numerical number in such a manner that order of a sign variation of the numerical number varies between the parameter units.
